(19) United States
(12) Patent Application Publication
(10) Pub. No.: US 2008/0028029 A1
(43) Pub. Date: Jan. 31, 2008

(54) Method and apparatus for determining whether an email message is spam

(76) Inventor: Matt E. Hart, Lunenburg, MA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/497,211

(22) Filed: Jul. 31, 2006

(51) Int. Cl. G06F 15/16

(52) U.S. Cl. 709/206

(57) ABSTRACT

One embodiment of the present invention provides a system that determines whether an email message is spam. During operation the system receives a rule to determine whether an email message is spam. Note that rules are substantially more complex and powerful than email signatures. Furthermore, a rule can be shared among users. Specifically, the rule can be created by a first user to determine whether an email message sent to the first user is spam. Next, the system can receive an email message which is destined to a second user. The system can then use the rule to determine whether the email message is spam.

### BACKGROUND

### Related Art

Spam has become a very serious problem on the Internet. Email servers are constantly bombarded with thousands, if not millions, of spam emails every day. Some studies have shown that spam costs billions of dollars to businesses, including lost productivity and the equipment and manpower required to combat the problem.

Spam emails are often closely associated to more serious crimes. Many spam emails contain advertisements for illegal products and/or services. Some spam emails contain links to malicious websites that are designed to extract sensitive information from users. For these reasons, it is vitally important to combat spam.

Millions of dollars have been spent on designing techniques and systems to combat spam. However, users continue to receive a large number of spam messages because spammers have managed to circumvent prior art techniques.

Prior art techniques for blocking spam typically use email signatures which look for a specific set of domain names and/or words to identify spam. However, these techniques can be easily circumvented. For example, many spam emails intentionally misspell words to circumvent prior art techniques. If an email contains misspelled words, it can fool prior art techniques which look for the correct spelling of the words and/or phrases. Even if the prior art technique looks for certain misspellings, a spammer can circumvent the prior art technique by using a misspelling that is not being checked. For example, although phrases such as “no money down” and “no munny dawn” may be blocked by prior art techniques, misspellings such as “n0 m0ny d0n” may get through to the user.

Spam emails may also be detected based on the sender's email address or domain name. However, this technique is also not effective. Spammers often spoof the sender's email address or domain name so that the email seems to originate from a legitimate organization. Furthermore, it is relatively easy to obtain a new domain name. Hence, even if a spammer does not spoof a legitimate domain name, the spammer can circumvent prior art techniques by obtaining new domain names.

### SUMMARY

One embodiment of the present invention provides a system that determines whether an email message is spam. During operation the system receives a rule to determine whether an email message is spam. Note that rules are substantially more complex and powerful than email signatures. Furthermore, a rule can be shared among users. Specifically, the rule can be created by a first user to determine whether an email message sent to the first user is spam. Next, the system can receive an email message which is destined to a second user. The system can then use the rule to determine whether the email message is spam.

In a variation on this embodiment, the rule is specified using a programming language, which can include, but is not limited to: (a) Microsoft Visual Basic for Applications, which is an event-driven programming language, (b) Python, which is an interpreted programming language, (c) PHP, which is a reflective programming language, or (d) C#, which is an object-oriented programming language.

In a variation on this embodiment, the system determines whether the email message is spam by determining a geographical location associated with the IP (Internet Protocol) address of a link within the first email message.

In a variation on this embodiment, the system determines whether the email message is spam by determining the IP addresses or domain names of systems along a route from a source IP address to a destination IP address which are associated with the email message. The source IP address can be associated with the system that is trying to determine whether the email message is spam. The destination IP address can be associated with the sender's email address or with the domain name of a link within the email message. Note that the system can use a “traceroute” process to determine the intermediate systems along the route from a source IP address to a destination IP address.

In a variation on this embodiment, the system determines whether the email message is spam by determining whether the domain name of a link within the first email message is in a list of domain names that are associated with spam emails.

In a variation on this embodiment, the system determines whether the email message is spam by indexing a word within the email message based on the word's pronunciation. Specifically, the system can use a process similar to Soundex to index a word within the email message.

In a variation on this embodiment, the system can receive a request to apply the rule to email messages that are destined to the second user.

In a variation on this embodiment, the system can receive a rating for the rule which indicates the rule's effectiveness.

### BRIEF DESCRIPTION OF THE FIGURES

FIG. 1 illustrates a network that is coupled with a number of network nodes in accordance with an embodiment of the present invention.

FIG. 2 presents a flowchart that illustrates a process for determining whether an email message is spam in accordance with an embodiment of the present invention.

FIG. 3 illustrates an apparatus for determining whether an email message is spam in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Network

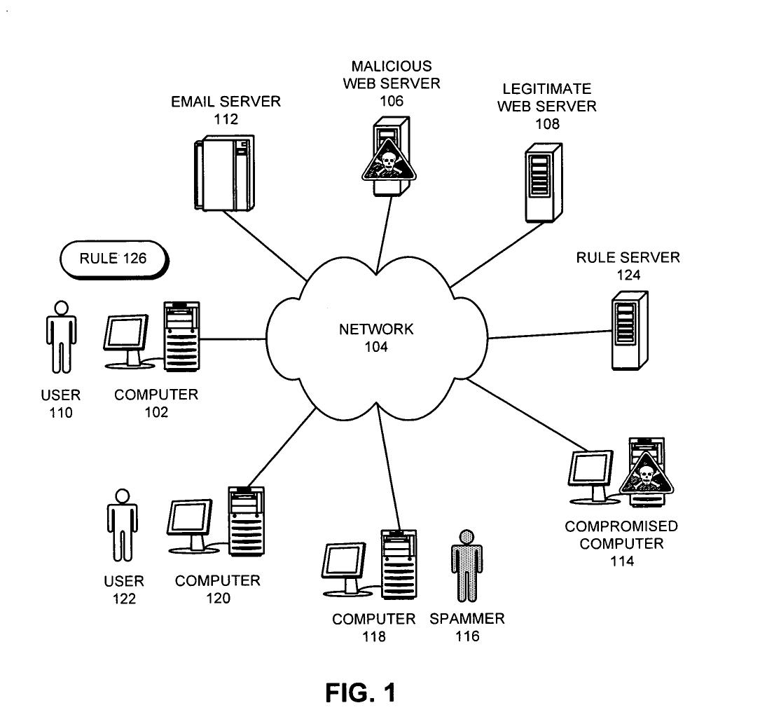

FIG. 1 illustrates a network that is coupled with a number of network nodes in accordance with an embodiment of the present invention.

Network 104 can be coupled with computer 102, email server 112, malicious web-server 106, legitimate web-server 108, rule server 124, compromised computer 114, computer 118, and computer 120.

Network 104 can generally comprise any type of wire or wireless communication channel capable of coupling together network nodes. This includes, but is not limited to, a local area network, a wide area network, or a combination of networks, or other network enabling communication between two or more computing systems. In one embodiment of the present invention, network 104 comprises the Internet.

A network node, such as a computer 102, can generally include any type of communication device capable of communicating with other network nodes via a network. This includes, but is not limited to, a computer system based on a microprocessor, a mainframe computer, a server, a printer, a video camera, an external disk drive, a router, a switch, a personal organizer, a mobile phone, or other computing systems capable of processing data.

Network 104 enables a network node, such as, computer 102, to communicate with another network node, such as, email server 112.

Users 110 and 122 may use computers 102 and 120, respectively, to send and receive emails. Spammer 116 may use computer 118 to send spam emails to users 110 and 122. (Note that a spammer is a user who sends spam emails.)

### Spam

Spammers typically obtain email addresses by scanning newsgroup postings, stealing Internet mailing lists, or searching the Web for addresses. Spam costs money to users, both directly by using up valuable time and disk space, and indirectly by costing ISPs and telecommunication companies to use their resources to transmit these messages over their networks. Some studies have shown that spam costs billions of dollars to businesses which includes lost productivity and the equipment and manpower required to combat the problem.

Furthermore, spam emails are often related to more serious crimes. Spam is often sent using compromised computers. For example, spammer 116 may use compromised computer 114 to send spam emails. Some spam emails contain links to malicious websites that are designed to extract sensitive information from users. Spam emails often contain advertisements for illegal products and services. For example, spammer 116 may send a spam email to user 110 which contains a link to malicious web server 106. Alternatively, the spam email may contain a link to legitimate web server 108 which hosts a website that sells illegitimate products. For these reasons, it is vitally important to combat spam.

Millions of dollars have been spent on designing techniques and systems to combat spam. However, users continue to receive a large number of spam messages because spammers have managed to circumvent prior art anti-spam technologies.

Prior art techniques for blocking spam typically use email signatures which look for a specific set of domain names or words to identify spam. However, these techniques can be very easy to circumvent.

Web email services like postini.com or yahoo.com enable users to notify the email service when the users receive spam. For example, users 110 and 122 can notify email server 112 when they receive spam emails from spammer 116. An email service can then use the sender's email addresses and/or the subject lines in these spam messages to develop email signatures which can then be used by email server 112 to block subsequent spam emails. However, email users at such web sites continue to receive spam because spammers can easily circumvent anti-spam techniques which use email signatures to determine whether an email is spam or not.

Recently, instead of using spam emails that contain text, spammers are creating emails that contain images of the spam text. Prior art anti-spam techniques cannot be used with such spam emails because prior art techniques are based on text processing. Note that, theoretically it is possible to use optical character recognition (OCR) to extract the text message contained in the image, and then apply prior art anti-spam techniques to the extracted text message. However, since OCR requires a lot of computational resources, this is an infeasible solution for detecting spam.

### Rules

One embodiment of the present invention uses rules for determining whether an email message is spam or not. Note that a rule is substantially more complex and powerful than an email signature. An email signature usually checks for words in the email's subject and/or the email's header that are characteristic to spam. Rules, on the other hand, specify instructions of how to use a number of pieces of information associated with the email to determine whether an email is spam or not.

Most email users can identify spam and forward the spam to their email service provider, who can create email signatures based on these spam emails. In contrast, since rules are substantially more difficult to create, a typical email user is not expected to have the technical sophistication to create an effective rule.

A rule can use a number of pieces of information associated with the email. For example, a rule can determine an email to be spam if 90% or more words within the email are “arbitrarily” misspelled. When a human misspells a word, the misspelled word is often phonetically equivalent to the actual word. However, when spammers misspell words to circumvent an anti-spam technique, the misspellings are usually “arbitrary” in nature.

In one embodiment, the system can use a process (e.g., Soundex) to determine whether a misspelled word is phonetically equivalent to a correct word. If the word is phonetically equivalent, the system can determine that the word was unintentionally misspelled by a user. Otherwise, if the misspelled word is not phonetically equivalent to a correct word, the system can determine that the word was intentionally misspelled to circumvent an anti-spam technique. For example, the system can determine that “m0ney” is a word that was intentionally misspelled by a spammer to thwart anti-spam techniques.

Spam emails often contain links to websites which may be used to sell illegal products or services. A rule can determine whether an email is spam if it contains a link to a website which is known to be involved in illegal activities. Specifically, a rule can match the website's domain name against a domain name “blacklist” to determine whether the email is spam or not. The domain name blacklist can contain a list of website domain names which are associated with spam emails. Note that even if a website is not illegal or malicious, the website may be included in the blacklist if it is associated with spam emails. For example, a legitimate commercial website may use spam emails to attract users to their website.

Prior art techniques typically use the email sender's domain name to determine whether the email is spam or not. In contrast, an embodiment of the present invention uses the domain name of a link within the email message. It is very easy to spoof the email's sender. However, it is more difficult to change the domain name of a website. Hence, spammers often send email messages using different email senders, but with the same link embedded within each email message.

For example, spammer 116 may send spam emails to user 110, but spoof the sender's domain name so that the emails may appear to be coming from a number of different users and/or organizations. However, in each of these spam emails, spammer 116 may include a link to malicious web server 106. Prior art techniques which detect spam based on the sender's email address and/or domain may not be able to detect all of these spam emails. In contrast, an embodiment of the present invention which detects spam using the domain name of a link within the email message will correctly detect all of these spam emails because all of the spam emails contain a link to malicious web server 106.

Although changing a website's domain name may be more difficult than spoofing an email's sender, website operators who use spam to lure users to their websites often keep changing their domain name to evade website blocking technologies and/or law enforcement agencies. However, these websites are often hosted using a web server that has either the same IP (Internet Protocol) address or an IP address that belongs to the same block of IP addresses. Hence, instead of matching the domain name of the link against a blacklist, a rule can resolve a link to its IP address, and match the IP address against a blacklist of IP addresses. Note that obtaining a new IP address is more difficult than obtaining a new domain name. Hence, using a rule that checks the IP address of links within an email can be substantially more effective in detecting spam than prior art techniques which use email signatures.

In one embodiment, a rule determines whether an email is spam by determining a geographical location associated with an IP address for a link within the email message. For example, a rule may block all emails that originate from a specific geographical region (e.g., Russia) and which have a large number of misspelled words. Note that a domain name may not always be associated with a geographical location. For example, a “.com” website can be located anywhere in the world. However, blocks of IP addresses are typically allocated to ISPs or organizations, who serve a limited geographical area. Specifically, an embodiment may first resolve the domain name of a link to its IP address. Next, the system may determine the geographical location associated with the IP address by determining the registered owner of the IP address.

A rule can use the contents of a website link to determine whether the email that contains the website link is spam or not. For example, the system can receive an email that contains a website link. Next, the system can navigate to the website link and receive the contents of the website. The system can then determine whether the email is spam or not using the contents of the website. Some spam emails are designed to determine whether the recipient's email address is valid or not. In such spam emails, navigating to a website link contained within the spam email can be disadvantageous because it may enable the spammer to validate the email address. Hence, in such situations, it may not be preferable to use this technique to determine whether an email is spam or not.

Further, in one embodiment, a rule may perform a “traceroute” to the IP address of the email sender or to the IP address of a website link within the email message. A traceroute operation can reveal the IP addresses and/or domain names of systems (e.g., routers and/or switches) along the route from one IP address to another. The IP addresses and/or domain names of these intermediate systems can be used to determine whether the email is spam or not. Note that, in contrast to navigating to a website, performing a traceroute cannot enable a spammer to ascertain the validity of the recipient's email address.

Rules can be described using a programming language. For example, Microsoft Outlook clients can use Visual Basic for Applications to describe the rules. (Note that “Microsoft,” “Visual Basic,” and “Outlook” may be trademarks of Microsoft Corporation which may be registered in the United States and/or other countries.) Alternatively, other scripting languages, such as, C#, Python, or PHP, can also be used to describe the rules. In one embodiment, a rule can be described in a standardized, platform independent programming language that is specifically designed to describe rules.

Rules can be executed by a mail server or a mail transfer agent to determine whether an email is spam or not. Specifically, rules can be used by Sendmail or Postfix, which are popular mail transfer agents.

A user can upload a spam rule to a server which can apply the rule to subsequent emails that are destined to the user. Alternatively, the user can apply the rule to emails after downloading them from a server. In another embodiment, the user can create a rule in two parts. The user can upload a first part of a rule to a server which can apply the first part to emails that are destined to the user. Next, the user can apply a second part of the rule after downloading emails from the server.

### Sharing Rules

Creating effective rules for detecting spam can require a high level of technical sophistication. For example, many users may not know how to use traceroute to detect spam emails. Hence, many users may not be able to create effective spam rules. However, those users who have the technical expertise may be able to create effective rules. Unfortunately, prior art techniques do not enable technically savvy users to use their expertise to help other users to block email spam.

One embodiment of the present invention enables users to share spam rules with one another. A user can request an email server to apply a rule that was created by another user. Specifically, a user can browse through a set of rules which were created by other users. Next, the user can request the system to apply one or more of these rules to emails that are destined to the user.

In one embodiment, a rule can be stored at a rule server. For example, user 110 can create rule 126 and send it to rule server 124. Next, user 122 can browse through the rules stored on rule server 124 and select rule 126. User 122 can then request email server 112 to apply rule 126 to emails that are destined to user 122. Email server 112 may receive rule 126 from rule server 124 and use it to detect spam emails that are destined to user 122. Alternatively, an email client on computer 120 may receive rule 126 and use it to detect spam emails.

Each rule can be associated with a rating which may be determined using a number of factors. For example, the rating can be determined by asking users to explicitly rate a rule once they have used it. A rule's rating may also be determined using the rule's popularity. Alternatively, a user may be asked to report false positives (i.e., a legitimate email which was determined to be spam) and false negatives (i.e., a spam email which was determined to be legitimate) for a rule. The system may determine the rule's rating using the frequency of false positives and false negatives.

Spammers are always trying to find techniques to circumvent existing anti-spam technology. Hence, these anti-spam rules usually need to be constantly updated. Enabling technically sophisticated users to share their rules with other users can ensure that the anti-spam rules remain effective against spammers. In one embodiment, a user may download a rule for editing and/or updating purposes. Once the user has made appropriate changes to the rule, the user may upload the updated rule to the server which may then be used by other users to detect spam emails.

### Determining Whether an Email Message is Spam

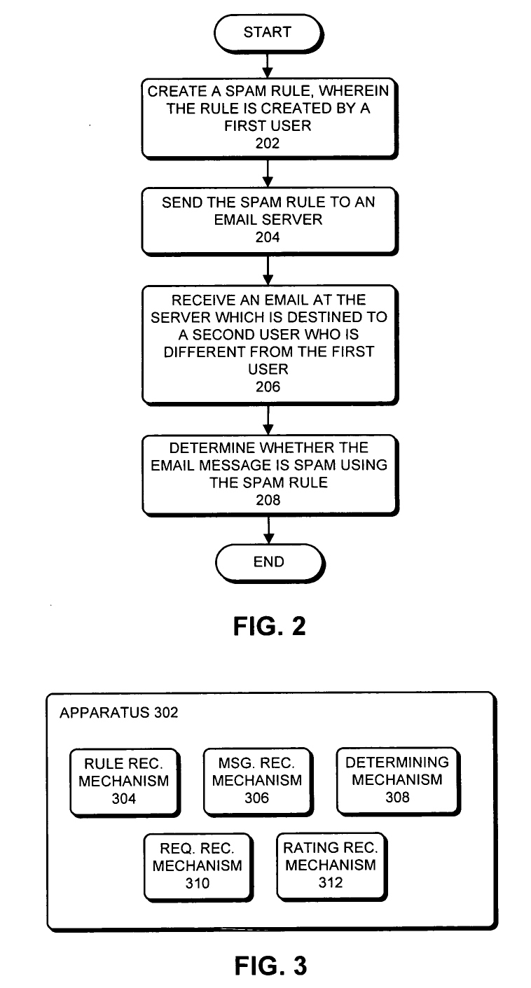

FIG. 2 presents a flowchart that illustrates a process for determining whether an email message is spam in accordance with an embodiment of the present invention.

The process usually begins with creating a rule to determine whether an email message is spam (step 202).

Rule 126 can be created by user 110 to determine whether an email message sent to him or her is spam. Note that the rule can be described using a programming language.

Next, an email server can receive the rule (step 204). For example, user 110 can send rule 126 to email server 112. In one embodiment, the rule can be sent to rule server 124. The rule server can then send the rule to an email server. Alternatively, the rule server may be used by an email client or an email server to determine whether an email is spam. In one embodiment, email server 112 is a Microsoft Exchange Server.

The email server then receives an email which is destined to another user (step 206).

For example, email server 112 may receive an email which is destined to user 122. Note that user 110 may be an expert in anti-spam technology who is capable of creating effective rules, whereas user 122 may not have such technical expertise and may not be able to create effective rules.

Next, the system may determine whether the email message is spam using the rule (step 208).

For example, email server 112 may use rule 126 to determine whether an email destined to user 122 is spam or not. In one embodiment, rule 126 may be applied at the email client. For example, computer 120 may use rule 126 to determine whether an email is spam or not.

FIG. 3 illustrates an apparatus for determining whether an email message is spam in accordance with an embodiment of the present invention.

Apparatus 302 can comprise rule-receiving mechanism 304, message-receiving mechanism 306, and determining mechanism 308. User 110 may create a rule using computer 102. Next, the rule may be received by an email server using rule-receiving mechanism 304. The email server may then receive an email using message-receiving mechanism 306. Next, the email server may use determining mechanism 308 to use the rule to determine whether an email message is spam.

Note that apparatus 302 may further comprise a request-receiving mechanism 310 which is configured to receive a request to apply a rule to email messages that are destined to a specific user. Further, apparatus 302 may also comprise a rating-receiving mechanism 312 which is configured to receive a rating for a rule which indicates the rule's effectiveness.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method to determine whether an email message is spam, the method comprising:
receiving a rule to determine whether an email message is spam, wherein the rule is created by a first user to determine whether an email message sent to the first user is spam;
receiving a first email message which is destined to a second user who is different from the first user; and
determining whether the first email message is spam using the rule.

2. The method of claim 1, wherein the rule is specified using a programming language, which can include:
Microsoft Visual Basic for Applications, which is an event-driven programming language;
Python, which is an interpreted programming language;
PHP, which is a reflective programming language; or
C#, which is an object-oriented programming language.

3. The method of claim 1, wherein determining whether the first email message is spam involves determining a geographical location associated with the IP (Internet Protocol) address of a link within the first email message.

4. The method of claim 1,
wherein the first email message is associated with a source IP (Internet Protocol) address and a destination IP address; and
wherein determining whether the first email message is spam involves determining the IP addresses or domain names of systems along a route from the source IP address to the destination IP address.

5. The method of claim 1, wherein determining whether the first email message is spam involves determining whether the domain name of a link within the first email message is in a list of domain names that are associated with spam emails.

6. The method of claim 1, wherein determining whether the first email message is spam involves indexing a word within the first email message based on the word's pronunciation.

7. The method of claim 1, wherein the method further comprises:
receiving a request to apply the rule to email messages that are destined to the second user; and
receiving a rating for the rule which indicates the rule's effectiveness.

8. A computer-readable storage medium storing instructions that when executed by a computer cause the computer to perform a method to determine whether an email message is spam, the method comprising:
receiving a rule to determine whether an email message is spam, wherein the rule is created by a first user to determine whether an email message sent to the first user is spam;
receiving a first email message which is destined to a second user who is different from the first user; and
determining whether the first email message is spam using the rule.

9. The computer-readable storage medium of claim 8, wherein the rule is specified using a programming language, which can include:
Microsoft Visual Basic for Applications, which is an event-driven programming language;
Python, which is an interpreted programming language;
PHP, which is a reflective programming language; or
C#, which is an object-oriented programming language.

10. The computer-readable storage medium of claim 8, wherein determining whether the first email message is spam involves determining a geographical location associated with the IP (Internet Protocol) address of a link within the first email message.

11. The computer-readable storage medium of claim 8,
wherein the first email message is associated with a source IP (Internet Protocol) address and a destination IP address; and
wherein determining whether the first email message is spam involves determining the IP addresses or domain names of systems along a route from the source IP address to the destination IP address.

12. The computer-readable storage medium of claim 8, wherein determining whether the first email message is spam involves determining whether the domain name of a link within the first email message is in a list of domain names that are associated with spam emails.

13. The computer-readable storage medium of claim 8, wherein determining whether the first email message is spam involves indexing a word within the first email message based on the word's pronunciation.

14. The computer-readable storage medium of claim 8, wherein the method further comprises:
receiving a request to apply the rule to email messages that are destined to the second user; and
receiving a rating for the rule which indicates the rule's effectiveness.

15. An apparatus to determine whether an email message is spam, the apparatus comprising:
a rule-receiving mechanism configured to receive a rule to determine whether an email message is spam, wherein the rule is created by a first user to determine whether an email message sent to the first user is spam;
a message-receiving mechanism configured to receive a first email message which is destined to a second user who is different from the first user; and
a determining mechanism configured to determine whether the first email message is spam using the rule.

16. The apparatus of claim 15, wherein the rule is specified using a programming language, which can include:
Microsoft Visual Basic for Applications, which is an event-driven programming language;
Python, which is an interpreted programming language;
PHP, which is a reflective programming language; or
C#, which is an object-oriented programming language.

17. The apparatus of claim 15, wherein the determining mechanism is configured to determine a geographical location associated with the IP (Internet Protocol) address of a link within the first email message.

18. The apparatus of claim 15,
wherein the first email message is associated with a source IP (Internet Protocol) address and a destination IP address; and
wherein the determining mechanism is configured to determine the IP addresses or domain names of systems along a route from the source IP address to the destination IP address.

19. The apparatus of claim 15, wherein the determining mechanism is configured to determine whether the domain name of a link within the first email message is in a list of domain names that are associated with spam emails.

20. The apparatus of claim 15, wherein the determining mechanism is configured to index a word within the first email message based on the word's pronunciation.

21. The apparatus of claim 15, wherein the apparatus further comprises:
a request-receiving mechanism configured to receive a request to apply the rule to email messages that are destined to the second user; and
a rating-receiving mechanism configured to receive a rating for the rule which indicates the rule's effectiveness.
